(19) United States
(12) Patent Application Publication
(10) Pub. No.: US 2018/0361975 A1
(43) Pub. Date: Dec. 20, 2018

(54) SEATBELT DEVICE

(71) Applicant: KABUSHIKI KAISHA TOKAI-RIKA-DENKI-SEISAKUSHO, Aichi (JP)

(72) Inventors: Yuya NAGATA, Aichi (JP); Takahiro OSAKI, Aichi (JP); Tomonari UMAKOSHI, Aichi (JP); Takuhiro SAITO, Aichi (JP)

(21) Appl. No.: 15/781,909

(22) PCT Filed: Nov. 29, 2016
(86) PCT No.: PCT/JP2016/085449

§ 371 Date: Jun. 6, 2018

(30) Foreign Application Priority Data
Dec. 15, 2015 (JP) 2015-244542

(51) Int. Cl. B60R 21/015; B60R 22/02; B60R 22/48; B60R 22/405

(52) U.S. Cl. CPC B60R 21/01548; B60R 22/023; B60R 2022/1806; B60R 22/405; B60R 22/48

(57) ABSTRACT

In a seatbelt device, when paying out webbing from a spool of a webbing take-up device to fit the webbing over the body of an occupant, drive of a first motor of the webbing take-up device is controlled based on the magnitude of a signal level of a load detection signal output by a load sensor according to the physical build of the occupant, and pulse data stored in a storage unit corresponding to each signal level of the load detection signal.

### TECHNICAL FIELD

The present invention relates to a seatbelt device capable of paying out webbing from a spool when an occupant puts on the webbing.

### BACKGROUND ART

Japanese Patent Application Laid-Open (JP-A) No. 2012-56349 discloses an example of a seatbelt device in which a webbing take-up device-side motor rotates a spool in a send-out direction such that the webbing is sent out from the spool when an occupant puts on the webbing.

However, in the configuration disclosed in JP-A No. 2012-56349, the buckle is moved by a buckle-side motor, and operation of the webbing take-up device-side motor is coordinated with, for example, the speed at which the buckle is moved by the buckle-side motor. Control of the webbing take-up device-side motor is therefore complex.

### SUMMARY OF INVENTION

### Technical Problem

In consideration of the above circumstances, an object of the present invention is to obtain a seatbelt device enabling simple control of a drive section when paying out webbing from a spool.

### Solution to Problem

A seatbelt device of a first aspect of the present disclosure includes a spool, a buckle, a drive section, and a controller. The spool is rotated in a send-out direction in order to send out webbing. The buckle is capable of engaging with a tongue provided to the webbing. The drive section is driven to rotate the spool in the send-out direction. The controller drives the drive section so as to rotate the spool by a predetermined specific amount in the send-out direction, in response to engagement of the tongue with the buckle.

In the seatbelt device of the first aspect of the present disclosure, the drive section is driven by the controller when the tongue is engaged with the buckle. The spool is thereby rotated by the predetermined specific amount in the send-out direction to send out the webbing from the spool, thus enabling a sense of constraint felt by occupant from the webbing when the webbing is fitted over the body of the occupant to be suppressed. Moreover, the send-out direction rotation amount of the spool by the drive force of the drive section is the predetermined specific amount, thereby enabling simple control of the drive of the drive section by the controller.

A seatbelt device of a second aspect of the present disclosure is the seatbelt device of the first aspect, further including a storage section and a detector. The storage section stores send-out direction rotation amount data for the spool, the rotation amount data being set according to values of a parameter that fluctuates according to changes in a specific condition. The detector detects a value of the parameter. Moreover, the controller drives the drive section by reading from the storage section the rotation amount data corresponding to the parameter value detected by the detector.

In the seatbelt device of the second aspect of the present disclosure, the storage section stores the send-out direction rotation amount data for the spool that is set according to values of a parameter that fluctuates according to changes in a specific condition. The controller drives the drive section by reading from the storage section the rotation amount data corresponding to the parameter value detected by the detector. This thereby enables a length of the webbing appropriate to the specific condition to be sent out from the spool.

A seatbelt device of a third aspect of the present disclosure is the seatbelt device of either the first or the second aspect, wherein the controller drives the drive section so as to send out the webbing from the spool by a length greater than or equal to a difference between a pre-stored amount of the webbing sent out from the spool in a fitted state of the webbing over the body of an occupant, and an amount of the webbing sent out from the spool when the tongue is engaged with the buckle.

In the seatbelt device of the third aspect of the present disclosure, the controller controls drive of the drive section so as to drive the drive section to send out the webbing from the spool by a length greater than or equal to the difference between the pre-stored amount of the webbing sent out from the spool in the fitted state of the webbing over the body of the occupant, and the amount of the webbing sent out from the spool when the tongue is engaged with the buckle. After driving the drive section, the amount of the webbing sent out from the spool is therefore not less than the amount of the webbing sent out from the spool in the fitted state of the webbing over the body of the occupant. This thereby enables a sense of constraint from the webbing felt by the occupant when the webbing is fitted over the body of the occupant to be suppressed.

A seatbelt device of a fourth aspect of the present disclosure is the seatbelt device of any one of the first aspect to the third aspect, wherein the buckle is capable of moving in a vehicle up-down direction or in a vehicle front-rear direction. Moreover, the controller controls drive of the drive section, in response to engagement of the tongue with the buckle in a state in which the buckle has been moved toward a vehicle upper side or a vehicle front side.

In the seatbelt device of the fourth aspect of the present disclosure, the controller controls drive of the drive section, in response to engagement of the tongue with the buckle in a state in which the buckle has been moved toward the vehicle upper side or the vehicle front side. This thereby enables, for example, a sense of constraint from the webbing felt by the occupant when the buckle has been moved toward the vehicle lower side or the vehicle rear side in an engaged state of the tongue to the buckle to be suppressed.

### Advantageous Effects of Invention

As described above, the seatbelt device according to the present invention enables simple control of the drive section when paying out the webbing from the spool.

### BRIEF DESCRIPTION OF DRAWINGS

FIG. 1 is a face-on view of a seatbelt device according to a first exemplary embodiment, as viewed from a vehicle width direction inside of a vehicle applied with the seatbelt device.

FIG. 2 is a face-on view corresponding to FIG. 1, illustrating a state in which a buckle has been moved.

FIG. 3 is a control block diagram of a first motor of a webbing take-up device and a second motor of a buckle device.

FIG. 4 is a flowchart schematically illustrating control of a second motor of a buckle device.

FIG. 5 is a flowchart schematically illustrating control of a first motor of a webbing take-up device.

FIG. 6 is a flowchart schematically illustrating control of a fitting assist function of a second exemplary embodiment.

FIG. 7 is a flowchart schematically illustrating control of a first motor of a webbing take-up device when an occupant puts on webbing in the second exemplary embodiment.

### DESCRIPTION OF EMBODIMENTS

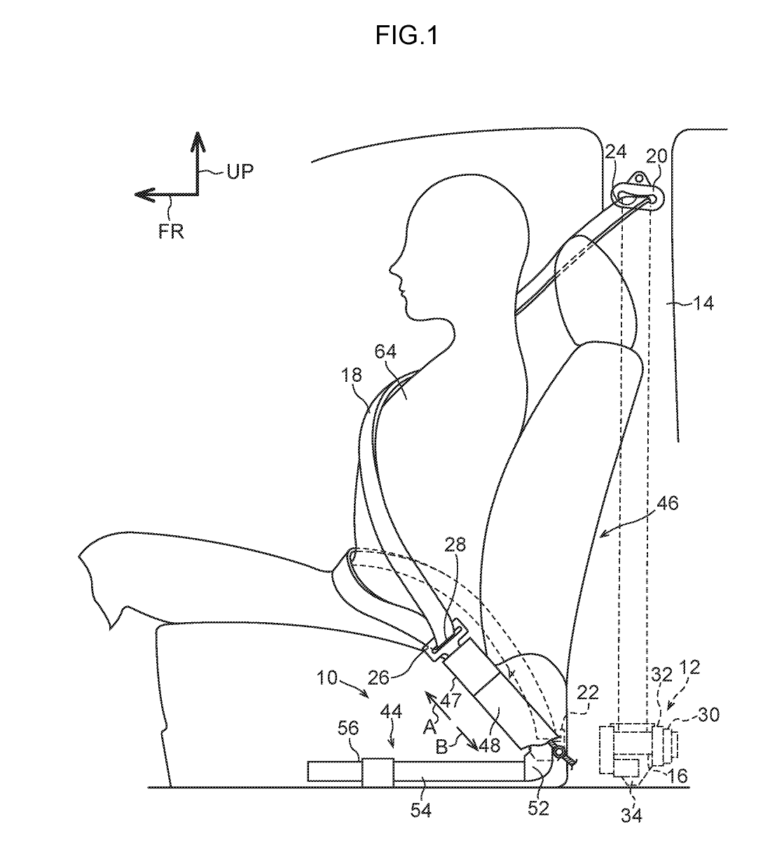

Explanation follows regarding exemplary embodiments of the present invention, with reference to FIG. 1 to FIG. 7. In each of the drawings, the arrow FR points toward the front side of a vehicle applied with a seatbelt device 10, and the arrow UP points toward the vehicle upper side thereof. In the explanation of each exemplary embodiment, configurations equivalent to those of a foregoing exemplary embodiment are allocated the same reference numerals, and detailed explanation thereof is omitted.

### Configuration of the First Exemplary Embodiment

As illustrated in FIG. 1, the seatbelt device 10 according to a first exemplary embodiment includes a webbing take-up device 12. The webbing take-up device 12 is disposed at a vehicle lower side of a center pillar 14 of the vehicle. The webbing take-up device 12 includes a spool 16. The spool 16 is formed in a substantially circular cylinder shape, and the direction of the central axis of the spool 16 runs substantially in a vehicle front-rear direction. The spool 16 is capable of rotating about its axial center, and a length direction base end portion of a webbing 18 of the seatbelt device 10 is anchored to the spool 16.

The webbing 18 is formed in an elongated belt shape, and the webbing 18 is taken up onto the spool 16 from the length direction base end portion when the spool 16 is rotated in a take-up direction. A length direction leading end side of the webbing 18 extends from the spool 16 toward the vehicle upper side. The length direction leading end side of the webbing 18 is then folded back toward the vehicle lower side as it passes through a slit 24 formed in a through anchor 20 supported by the center pillar 14.

An anchor plate 22 is provided in the vicinity of a vehicle lower side end portion of the center pillar 14. A length direction leading end portion of the webbing 18 that is folded back toward the vehicle lower side as it passes through the slit 24 in the through anchor 20 is anchored to the anchor plate 22. A portion of the webbing 18 between the anchor plate 22 and the through anchor 20 is provided with a tongue 26. A slit-shaped webbing insertion hole 28 is formed in the tongue 26, and the webbing 18 is inserted through the webbing insertion hole 28. The tongue 26 is thus capable of moving along the webbing 18.

Moreover, as illustrated in FIG. 1, the webbing take-up device 12 is provided with a locking mechanism 30. The locking mechanism 30 actuates in a vehicle emergency such as a vehicle collision. When the locking mechanism 30 is actuated, the locking mechanism 30 prevents the spool 16 of the webbing take-up device 12 from rotating in a send-out direction, this being the opposite direction to the take-up direction, thereby preventing the webbing 18 from being sent out from the spool 16.

The webbing take-up device 12 further includes a pre-tensioner 32. The pre-tensioner 32 actuates in a vehicle emergency such as a vehicle collision. When the pre-tensioner 32 actuates, the spool 16 of the webbing take-up device 12 is rotated in the take-up direction by the pre-tensioner 32, thereby taking up the webbing 18 onto the spool 16.

The webbing take-up device 12 also includes a first motor 34, serving as a drive section. An output shaft of the first motor 34 is mechanically linked to the spool 16 via a first drive force transmission section configured by a speed-reduction gear train, clutch mechanism, and the like. When the first motor 34 is rotated forward and the forward drive force of the first motor 34 is transmitted to the spool 16, the spool 16 is rotated in the send-out direction. When the first motor 34 is rotated in reverse and the reverse drive force of the first motor 34 is transmitted to the spool 16, the spool 16 is rotated in the take-up direction.

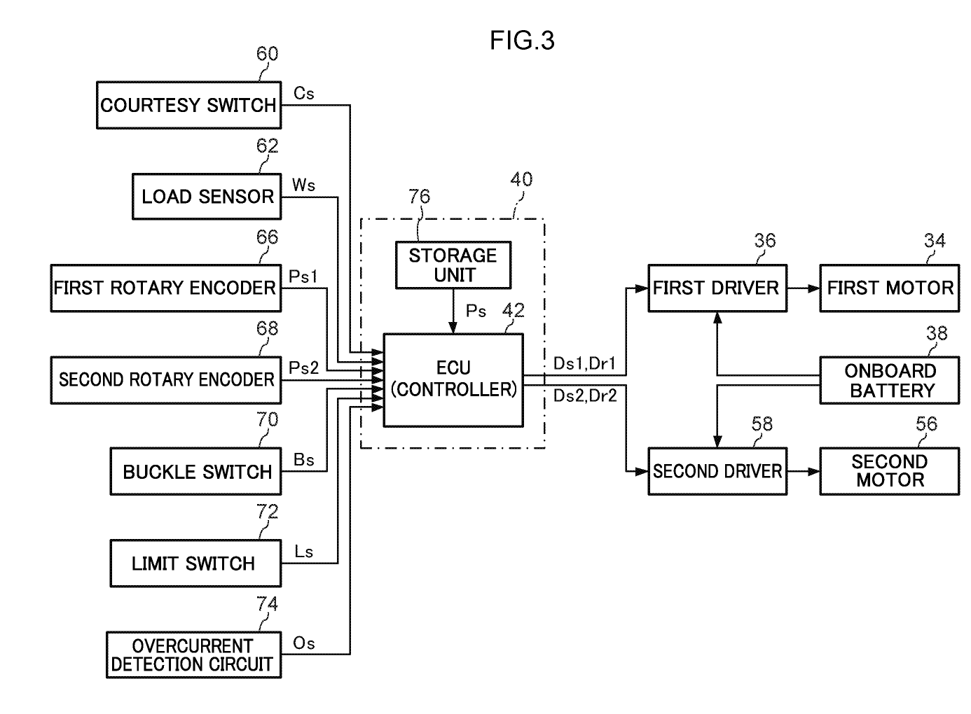

As illustrated in FIG. 3, the first motor 34 is electrically connected to a first driver 36. The first driver 36 is electrically connected to an onboard battery 38, and is also electrically connected to an ECU 42, serving as a controller configuring a control unit 40. When a first motor forward drive control signal Ds1 output by the ECU 42 switches from LOW level to HIGH level, the first motor 34 is driven forward, and when a first motor reverse drive control signal Dr1 output by the ECU 42 switches from LOW level to HIGH level, the first motor 34 is driven in reverse.

As illustrated in FIG. 1, the seatbelt device 10 includes a buckle device 44. The buckle device 44 is provided at the vehicle width direction inside of a seat 46 (on the opposite side of the seat 46 to the webbing take-up device 12) of the vehicle applied with the seatbelt device 10. The buckle device 44 includes a buckle 47. The buckle 47 is capable of engaging with the tongue 26 provided to the webbing 18 of the seatbelt device 10.

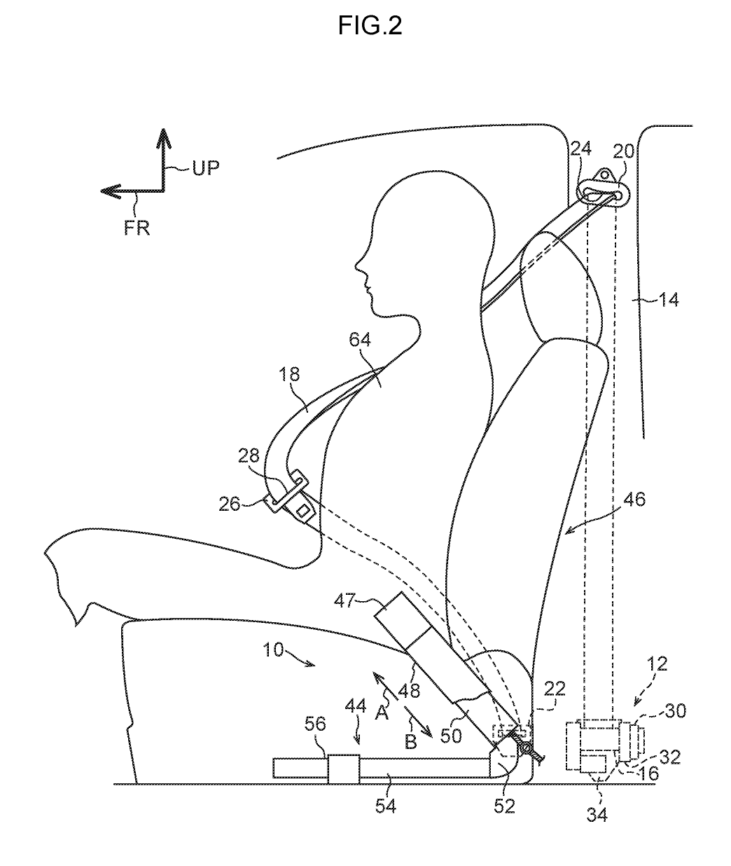

As illustrated in FIG. 2, the buckle device 44 includes a buckle cover 48 and a buckle guide 50. The length directions of both the buckle cover 48 and the buckle guide 50 are directions inclined toward the vehicle front-rear direction with respect to the vehicle up-down direction, and both the buckle cover 48 and the buckle guide 50 are tube shaped with rectangular cross-section profiles. Both the buckle cover 48 and the buckle guide 50 are open at both length direction ends, and the buckle 47 is provided at a vehicle upper side end portion of the buckle cover 48. The buckle guide 50 is inserted inside the buckle cover 48 through a vehicle lower side end portion of the buckle cover 48, such that the buckle cover 48 is capable of moving obliquely toward a vehicle front upper side (the arrow A direction side in FIG. 1 and FIG. 2) and obliquely toward a vehicle rear lower side (the arrow B direction side in FIG. 1 and FIG. 2), guided by the buckle guide 50.

As illustrated in FIG. 1, a wire guide 52 is provided at the vehicle lower side of a vehicle lower side end portion of the buckle guide 50. A guide rail 54 is provided at a vehicle front side of the wire guide 52. A slider (not illustrated in the drawings) is disposed inside the guide rail 54 so as to be capable of sliding in the vehicle front-rear direction. A length direction base end portion of a wire (not illustrated in the drawings), serving as a coupling member, is anchored to the slider. A length direction leading end side of the wire passes through the inside of the wire guide 52 and the inside of the buckle guide 50 so as to reach the inside of the buckle cover 48, and a length direction leading end portion of the wire is anchored to the buckle 47.

When a length direction base end portion of the wire inside the guide rail 54 slides toward the vehicle rear side together with the slider, a length direction leading end portion of the wire moves obliquely toward a vehicle front upper side, such that the buckle 47 moves obliquely toward the vehicle front upper side together with the buckle cover 48, as illustrated in FIG. 2. Conversely, when the length direction base end portion of the wire inside the guide rail 54 slides toward the vehicle front side together with the slider, the length direction leading end portion of the wire moves obliquely toward a vehicle rear lower side, such that the buckle 47 moves obliquely toward the vehicle rear lower side together with the buckle cover 48, as illustrated in FIG. 1.

Moreover, as illustrated in FIG. 1, a second motor 56 is provided at the vehicle front side of the guide rail 54. The second motor 56 is coupled to the slider inside the guide rail 54 via a second drive force transmission section (not illustrated in the drawings) configured by a speed-reduction gear train, a screw shaft of a ball screw (drive screw), or the like. When the second motor 56 is rotated forward, the slider slides toward the vehicle rear side inside the guide rail 54, and when the second motor 56 is rotated in reverse, the slider slides toward the vehicle front side inside the guide rail 54.

As illustrated in FIG. 3, the second motor 56 is electrically connected to a second driver 58. The second driver 58 is electrically connected to the onboard battery 38, and is also electrically connected to the ECU 42 of the control unit 40. When a second motor forward drive control signal Ds2 output by the ECU 42 of the control unit 40 switches from LOW level to HIGH level, the second motor 56 is driven forward, and when a second motor reverse drive control signal Dr2 output by the ECU 42 switches from LOW level to HIGH level, the second motor 56 is driven in reverse.

The ECU 42 of the control unit 40 is electrically connected to a vehicle-mounted courtesy switch 60. The courtesy switch 60 detects opening and closing of a vehicle door corresponding to the seat 46 applied with the seatbelt device 10, and a door open/closed signal Cs output by the courtesy switch 60 switches from HIGH level to LOW level when the vehicle door is closed after having been opened.

The ECU 42 of the control unit 40 is electrically connected to a load sensor 62 that serves as a detector. The load sensor 62 is provided to the seat 46 of the vehicle applied with the seatbelt device 10. When an occupant 64 sits on the seat 46, the seat 46 is subjected to load, serving as an example of a parameter, according to the physical build (body weight) of the occupant 64, serving as an example of a specific condition. The load sensor 62 outputs a load detection signal Ws at a signal level (for example, a voltage) corresponding to the magnitude of the load.

The ECU 42 of the control unit 40 is electrically connected to a first rotary encoder 66 that serves as a first revolution count detector. The first rotary encoder 66 is provided alongside the spool 16 of the webbing take-up device 12, or alongside a first rotating member that rotates coupled to rotation of the spool 16. The first rotary encoder 66 outputs a first pulse signal Ps1 each time the spool 16 has rotated by a particular angle.

The ECU 42 of the control unit 40 is electrically connected to a second rotary encoder 68 that serves as a second revolution count detector. The second rotary encoder 68 is provided alongside the output shaft of the second motor 56 of the buckle device 44, or alongside a second rotating member that rotates coupled to rotation of the output shaft of the second motor 56. The second rotary encoder 68 outputs a second pulse signal Ps2 each time the output shaft of the second motor 56 has rotated by a particular angle.

The ECU 42 of the control unit 40 is electrically connected to a buckle switch 70 that serves as a tongue engagement detector. The buckle switch 70 is provided to the buckle 47 of the buckle device 44. The buckle switch 70 outputs a tongue retention signal Bs that switches from LOW level to HIGH level when the tongue 26 provided to the webbing 18 of the seatbelt device 10 is engaged with the buckle 47 and the tongue 26 is retained by the buckle 47.

The ECU 42 of the control unit 40 is electrically connected to a limit switch 72 that serves as an initial position detector. The limit switch 72 is provided to the guide rail 54 of the buckle device 44. The limit switch 72 outputs a HIGH level initial position detection signal Ls in a state in which the slider is at an initial position inside the guide rail 54, and the initial position detection signal Ls output by the limit switch 72 switches from HIGH level to LOW level when the slider slides further toward the vehicle rear side than the initial position.

The ECU 42 of the control unit 40 is electrically connected to an overcurrent detection circuit 74 that serves as a fitted state detector. The overcurrent detection circuit 74 is provided to the first driver 36 that is electrically connected to the first motor 34 of the webbing take-up device 12. The overcurrent detection circuit 74 outputs an overcurrent detection signal Os that switches from LOW level to HIGH level when an overcurrent flows in the first motor 34 in a state in which the first motor 34 of the webbing take-up device 12 is being driven.

The ECU 42 of the control unit 40 is electrically connected to a storage unit 76 that serves as a storage section configuring the ECU 42 and the control unit 40. The storage unit 76 stores pulse data Ps, serving as rotation amount data, corresponding to signal levels of the load detection signal Ws output by the load sensor 62 provided to the seat 46. The pulse data Ps corresponds to a number of send-out direction revolutions of the spool 16 of the webbing take-up device 12. The spool 16 is rotated in the send-out direction by a length corresponding to the physical build (body weight) or the like of the occupant 64 by rotating the spool 16 of the webbing take-up device 12 in the send-out direction by an amount greater than or equal to the pulse data Ps, thus paying out the webbing 18 from the spool 16.

### Operation and Advantageous Effects of the First Exemplary Embodiment

### Operation of the Buckle Device 44

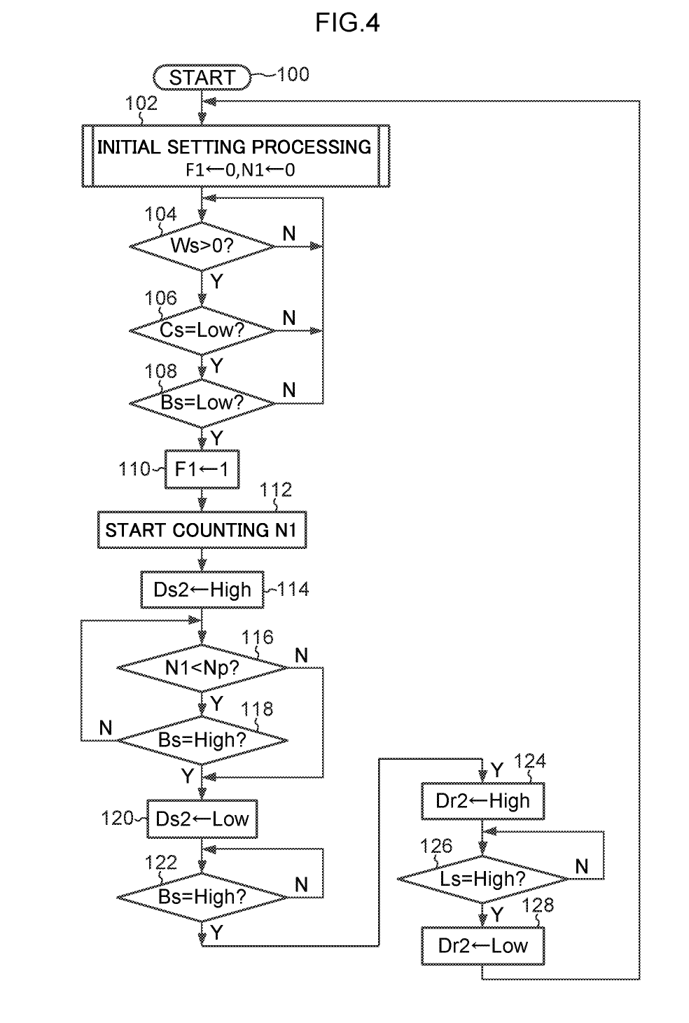

Next, explanation follows regarding control of the operation of the second motor 56 of the buckle device 44, with reference to the flowchart illustrated in FIG. 4.

In the present exemplary embodiment, when a vehicle door lock is unlocked, for example, at step 100 the control unit 40 begins controlling the operation of the second motor 56 of the buckle device 44. Next, at step 102, the ECU 42 of the control unit 40 performs initial setting processing, in which the ECU 42 of the control unit 40 resets a flag F1, and resets a count N1 of the second pulse signal Ps2 output by the second rotary encoder 68 of the buckle device 44.

Next, at step 104, the ECU 42 of the control unit 40 determines whether or not the load detection signal Ws output by the load sensor 62 is greater than 0, namely whether or not the occupant 64 is sitting in the seat 46 of the vehicle. Then at step 106, the ECU 42 of the control unit 40 determines whether or not the door open/closed signal Cs output by the courtesy switch 60 is LOW level, namely, whether or not the vehicle door is closed. Then, at step 108, the ECU 42 of the control unit 40 determines whether or not the tongue retention signal Bs output by the buckle switch 70 is LOW level, namely whether or not the tongue 26 is engaged with the buckle 47 of the buckle device 44.

At step 110, the ECU 42 sets the flag F1 to 1 in cases in which, based on step 104 to step 108, the ECU 42 of the control unit 40 has determined a state to exist in which the occupant 64 is in a seated state on the seat 46 of the vehicle and the door of the vehicle is closed, but the tongue 26 has not been engaged with the buckle 47 of the buckle device 44.

Next, at step 112, the ECU 42 of the control unit 40 begins counting the second pulse signal Ps2 output by the second rotary encoder 68 of the buckle device 44, and at step 114, the ECU 42 switches the second motor forward drive control signal Ds2 output by the ECU 42 from LOW level to HIGH level. The second motor 56 of the buckle device 44 is thereby driven forward, such that the forward drive force of the second motor 56 slides the slider inside the guide rail 54 of the buckle device 44 toward the vehicle rear side. Accordingly, when the length direction base end portion of the wire moves toward the vehicle rear side, the length direction leading end portion of the wire moves obliquely toward the vehicle front upper side, and the buckle 47 of the buckle device 44 also moves obliquely toward the vehicle front upper side together with the buckle cover 48 (see FIG. 2).

Next, at step 116, the ECU 42 of the control unit 40 determines whether or not the count N1 of the second pulse signal Ps2 output by the second rotary encoder 68 is less than a predetermined Np, namely, whether or not a movement amount of the buckle 47 of the buckle device 44 obliquely toward the vehicle front upper side is less than a specific stroke. At step 118, the ECU 42 of the control unit 40 determines whether or not the tongue retention signal Bs output by the buckle switch 70 is HIGH level, namely, whether or not the tongue 26 has been engaged with the buckle 47 of the buckle device 44.

At step 120, the ECU 42 switches the second motor forward drive control signal Ds2 output by the ECU 42 of the control unit 40 from HIGH level to LOW level in cases in which the movement amount of the buckle 47 of the buckle device 44 obliquely toward the vehicle front upper side is greater than or equal to the specific stroke, or in cases in which the tongue 26 has been engaged with the buckle 47 of the buckle device 44. The second motor 56 of the buckle device 44 is thus stopped.

Next, at step 122, the ECU 42 of the control unit 40 determines whether or not the tongue retention signal Bs output by the buckle switch 70 is HIGH level. At step 124, the ECU 42 switches the second motor reverse drive control signal Dr2 output by the ECU 42 of the control unit 40 from LOW level to HIGH level when the tongue 26 has been engaged with the buckle 47 of the buckle device 44 in this state. The second motor 56 of the buckle device 44 is thereby driven in reverse. When the second motor 56 of the buckle device 44 is driven in reverse, the buckle 47 of the buckle device 44 is moved obliquely toward the vehicle rear lower side together with the buckle cover 48.

Next, at step 126, the ECU 42 of the control unit 40 determines whether or not the initial position detection signal Ls output by the limit switch 72 is HIGH level. When the second motor 56 of the buckle device 44 is driven in reverse, the slider inside the guide rail 54 of the buckle device 44 slides toward the vehicle front side, and when the slider accordingly reaches the initial position, the initial position detection signal Ls output by the limit switch 72 switches from LOW level to HIGH level.

When the initial position detection signal Ls output by the limit switch 72 switches from LOW level to HIGH level, at step 128, the ECU 42 switches the second motor reverse drive control signal Dr2 output by the ECU 42 of the control unit 40 from HIGH level to LOW level, thereby stopping the second motor 56 of the buckle device 44.

In this manner, in the present exemplary embodiment, the buckle 47 of the buckle device 44 is moved obliquely toward the vehicle front upper side when the occupant 64 of the vehicle puts on the webbing 18. This thereby allows the occupant 64 to engage the tongue 26 with the buckle 47 of the buckle device 44 easily.

### Operation of the First Motor 34 of the Webbing Take-Up Device 12

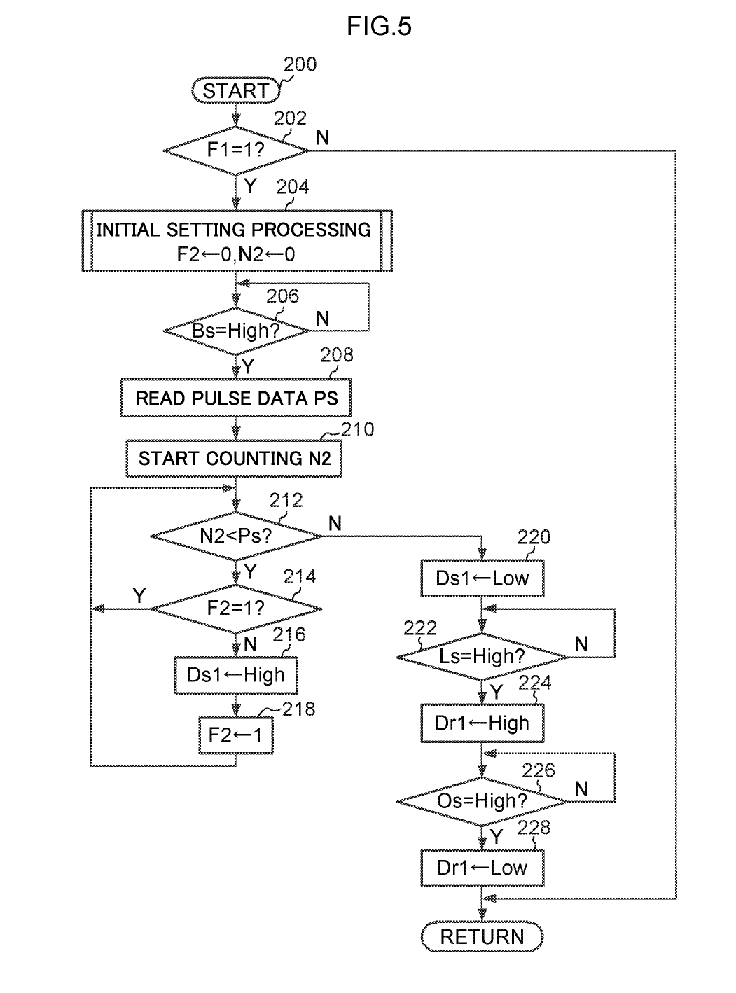

Next, explanation follows regarding control of the operation of the first motor 34 of the webbing take-up device 12, with reference to the flowchart illustrated in FIG. 5.

In the present exemplary embodiment, when the vehicle door lock is unlocked, for example, at step 200 the ECU 42 of the control unit 40 begins controlling the operation of the first motor 34 of the webbing take-up device 12. Next, at step 202, the ECU 42 of the control unit 40 determines whether or not the flag F1 described with reference to the control of the second motor 56 of the buckle device 44 is set to 1. If the flag F1 is not set to 1, the ECU 42 of the control unit 40 effectively adopts a standby state until the flag F1 has been set to 1.

As illustrated by the flowchart in FIG. 4, in the control of the second motor 56 of the buckle device 44, when the flag F1 has been set to 1 at step 110, the second motor 56 of the buckle device 44 is then driven forward at step 114. Namely, as illustrated by the flowchart in FIG. 4, in the control of the first motor 34 of the webbing take-up device 12, determining whether the flag F1 is set to 1 at step 202 corresponds to determination as to whether or not the buckle 47 of the buckle device 44 has been moved obliquely toward the vehicle front upper side.

As illustrated by the flowchart in FIG. 5, in cases in which the ECU 42 of the control unit 40 determines that the flag F1 has been set to 1 at step 202, at step 204, initial setting processing is performed in which the ECU 42 resets a flag F2 and a count N2 of the first pulse signal Ps1 output by the first rotary encoder 66 of the webbing take-up device 12. Next, at step 206, the ECU 42 of the control unit 40 determines whether or not the tongue retention signal Bs output by the buckle switch 70 of the buckle device 44 is HIGH level, namely whether or not the tongue 26 provided to the webbing 18 has been engaged with the buckle 47 of the buckle device 44.

When the tongue 26 is engaged with the buckle 47 of the buckle device 44, at step 208, the ECU 42 of the control unit 40 reads the pulse data Ps corresponding to the magnitude of the signal level of the load detection signal Ws output by the load sensor 62 from the storage unit 76. The storage unit 76 is stored with plural items of pulse data Ps. Each one of these items of pulse data Ps is set corresponding to an individual signal level magnitude of the load detection signal Ws. Accordingly, at step 208, the ECU 42 of the control unit 40 reads the pulse data Ps corresponding to the magnitude of the signal level of the load detection signal Ws, namely, corresponding to the physical build (body weight) or the like of the occupant 64 sitting in the seat 46 of the vehicle.

Next, at step 210, the ECU 42 of the control unit 40 begins counting the first pulse signal Ps1 output by the first rotary encoder 66 of the webbing take-up device 12. Then at step 212, the ECU 42 of the control unit 40 determines whether or not a count N2 for the first pulse signal Ps1 output by the first rotary encoder 66 is less than the pulse data Ps that has been read from the storage unit 76.

In cases in which the count N2 of the first pulse signal Ps1 output by the first rotary encoder 66 is less than the pulse data Ps, at step 214 the ECU 42 of the control unit 40 determines whether or not the flag F2 is set to 1. In this state, if the flag F2 is not set to 1, at step 216 ECU 42 switches the first motor forward drive control signal Ds1 output by the ECU 42 of the control unit 40 from LOW level to HIGH level. The first motor 34 of the webbing take-up device 12 is thereby driven forward. The forward drive force of the first motor 34 of the webbing take-up device 12 is transmitted to the spool 16, thereby rotating the spool 16 in the send-out direction, and paying out the webbing 18 from the spool 16. Next, at step 218, the ECU 42 of the control unit 40 sets the flag F2 to 1, and processing returns to step 212.

When the count N2 of the first pulse signal Ps1 output by the first rotary encoder 66 is greater than or equal to the pulse data Ps, at step 220, the ECU 42 switches the first motor forward drive control signal Ds1 output by the ECU 42 of the control unit 40 from HIGH level to LOW level. The first motor 34 of the webbing take-up device 12 is thereby stopped. Next, at step 220, the ECU 42 of the control unit 40 determines whether or not the initial position detection signal Ls output by the limit switch 72 is HIGH level.

Reverse drive of the second motor 56 of the buckle device 44 moves the slider inside the guide rail 54 of the buckle device 44 toward the vehicle front side, and when the initial position detection signal Ls output by the limit switch 72 switches from LOW level to HIGH level due to the slider reaching the initial position, at step 224 the ECU 42 switches the first motor reverse drive control signal Dr1 output by the ECU 42 of the control unit 40 from LOW level to HIGH level. The first motor 34 of the webbing take-up device 12 is thereby driven in reverse. The reverse drive force of the first motor 34 of the webbing take-up device 12 is transmitted to the spool 16, thereby rotating the spool 16 in the take-up direction such that the webbing 18 is taken up onto the spool 16, removing slack in the webbing 18 that is wrapped across the body of the occupant 64.

Next, take-up direction rotation of the spool 16 is restricted when the slack in the webbing 18 that is wrapped across the body of the occupant 64 has been removed and the spool 16 can no longer take up any of the webbing 18. When rotation of the output shaft of the first motor 34 is thus restricted, overcurrent flows in the first motor 34. When this overcurrent is detected by the overcurrent detection circuit 74, the overcurrent detection signal Os output by the overcurrent detection circuit 74 switches from LOW level to HIGH level.

When the ECU 42 of the control unit 40 has determined that the overcurrent detection signal Os output by the overcurrent detection circuit 74 has switched from LOW level to HIGH level at step 226, at step 228, the ECU 42 switches the first motor reverse drive control signal Dr1 output by the ECU 42 from HIGH level to LOW level. The first motor 34 of the webbing take-up device 12 is thereby stopped, placing that the webbing 18 in a fitted state over the body of the occupant 64.

Note that in the present exemplary embodiment, the first motor 34 of the webbing take-up device 12 is driven so as to send out a length of the webbing 18 from the spool 16 in accordance with the physical build (body weight) or the like of the occupant 64. It is thus possible to suppress a sense of constraint felt by the occupant 64 from the webbing 18, and in particular, a sense of constraint felt around the stomach of the occupant 64 from a lap belt portion of the webbing 18 between the tongue 26 and the anchor plate 22, when the buckle 47 is moved obliquely toward the vehicle rear lower side by drive force of the second motor 56 of the buckle device 44. This thereby enables the commercial appeal of the seatbelt device 10 to be enhanced.

Moreover, in the present exemplary embodiment, when controlling the drive of the first motor 34 of the webbing take-up device 12, there is no need to detect the tension of the webbing 18 or to detect the load of the second motor 56 of the buckle device 44. There is therefore no need for complicated coordination between drive control of the first motor 34 of the webbing take-up device 12 and drive control of the second motor 56 of the buckle device 44. This thereby enables the drive control of the first motor 34 of the webbing take-up device 12 and the drive control of the second motor 56 of the buckle device 44 to be suppressed from becoming complicated. This thereby enables manufacturing costs of the seatbelt device 10 to be suppressed, and so the commercial appeal of the seatbelt device 10 can be enhanced in this sense, too.

### Second Exemplary Embodiment

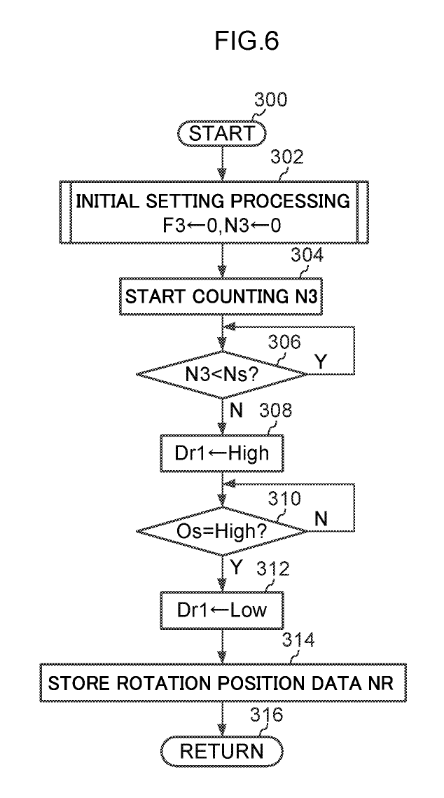

A second exemplary embodiment includes a fitting assist function that removes slack from the webbing 18 when the webbing 18 has become slack in a fitted state of the webbing 18 over the body of the occupant 64. First, explanation follows regarding the fitting assist function, with reference to the flowchart illustrated in FIG. 6.

As illustrated by the flowchart in FIG. 6, when a fitted state of the webbing 18 over the body of the occupant 64 has been achieved, at step 300 the ECU 42 of the control unit 40 begins control of the fitting assist function. Next, at step 302, initial setting processing is performed in which the ECU 42 of the control unit 40 resets a flag F3, and the ECU 42 resets a count N3 of the first pulse signal Ps1 output by the first rotary encoder 66 of the webbing take-up device 12.

Next, at step 304, the ECU 42 of the control unit 40 begins counting the first pulse signal Ps1 output by the first rotary encoder 66 of the webbing take-up device 12, and at step 304, the ECU 42 of the control unit 40 determines whether or not the count N3 of the first pulse signal Ps1 output by the first rotary encoder 66 is less than a preset number Ns. When the count N3 of the first pulse signal Ps1 output by the first rotary encoder 66 becomes greater than or equal to the preset number Ns due to a specific length of the webbing 18 having been sent out from the spool 16 as a result of the spool 16 rotating in the send-out direction from the fitted state of the webbing 18 over the body of the occupant 64, processing similar to the processing of step 224 to step 228 in the flowchart in FIG. 5 is performed at step 308 to step 312. Slack in the webbing 18 fitted over the body of the occupant 64 is thereby removed.

Next, at step 314, the ECU 42 of the control unit 40 computes rotation position data Nr, this being a count of the first pulse signal Ps1 output by the first rotary encoder 66 between a webbing fully-stored state in which the webbing 18 is not fitted over the body of the occupant 64 and in which no more of the webbing 18 can be taken up onto the spool 16 of the webbing take-up device 12, and a fitted state of the webbing 18 over the body of the occupant 64. The rotation position data Nr is stored in the storage unit 76 of the control unit 40.

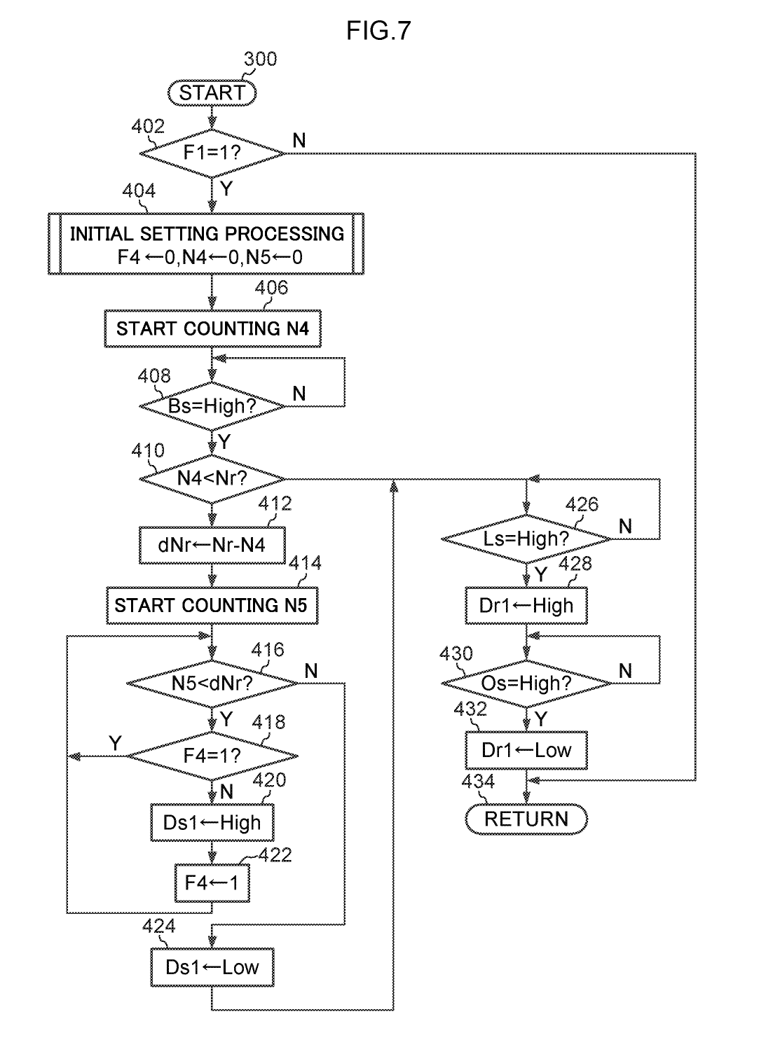

Next, explanation follows regarding control of the first motor 34 of the webbing take-up device 12 when fitting the webbing 18 over the body of the occupant 64 in the present exemplary embodiment, with reference to the flowchart illustrated in FIG. 7.

In the present exemplary embodiment, similarly to in the first exemplary embodiment, for example, when the vehicle door lock is unlocked, control of operation of the first motor 34 of the webbing take-up device 12 is started at step 400. Next, at step 402, similarly to at step 202 in FIG. 5, determination is made as to whether or not the flag F1, described in the context of control of the second motor 56 of the buckle device 44, is set to 1.

Next, at step 404, initial setting processing is performed, in which the ECU 42 of the control unit 40 resets a flag F4 and the ECU 42 of the control unit 40 resets counts N4, N5 of the first pulse signal Ps1 output by the first rotary encoder 66 of the webbing take-up device 12. Next, at step 406, the ECU 42 of the control unit 40 starts the count N4 of the first pulse signal Ps1 output by the first rotary encoder 66 of the webbing take-up device 12.

Next, at step 408, the ECU 42 of the control unit 40 determines whether or not the tongue retention signal Bs output by the buckle switch 70 of the buckle device 44 is HIGH level, namely whether or not the tongue 26 provided to the webbing 18 has been engaged with the buckle 47 of the buckle device 44. When the tongue 26 is engaged with the buckle 47 of the buckle device 44, at step 410 the ECU 42 of the control unit 40 determines whether or not the count N4 of the first pulse signal Ps1 output by the first rotary encoder 66 of the webbing take-up device 12 is less than the rotation position data Nr obtained during the control of the fitting assist function described above. When the count N4 of the first pulse signal Ps1 output by the first rotary encoder 66 is greater than or equal to the rotation position data Nr, at step 412 the ECU 42 of the control unit 40 computes a difference dNr between the rotation position data Nr and the count N4 of the first pulse signal Ps1.

Next, at step 414, the ECU 42 of the control unit 40 also starts the count N5 of the first pulse signal Ps1 output by the first rotary encoder 66 of the webbing take-up device 12. At step 416, the ECU 42 of the control unit 40 determines whether or not the count N5 of the first pulse signal Ps1 output by the first rotary encoder 66 is less than the difference dNr between the rotation position data Nr and the previously counted count N4 of the first pulse signal Ps1.

When the count N5 of the first pulse signal Ps1 output by the first rotary encoder 66 is less than the difference dNr between the rotation position data Nr and the previously counted count N4 of the first pulse signal Ps1, at step 418, the ECU 42 of the control unit 40 determines whether or not the flag F4 is set to 1. If the flag F4 is not set to 1, at step 420, the ECU 42 switches the first motor forward drive control signal Ds1 output by the ECU 42 of the control unit 40 from LOW level to HIGH level. The first motor 34 of the webbing take-up device 12 is thereby driven forward. Next, at step 422, the ECU 42 of the control unit 40 sets the flag F2 to 1, and processing returns to step 416.

When the count N5 of the first pulse signal Ps1 becomes greater than or equal to the difference dNr between the rotation position data Nr and the previously counted count N4 of the first pulse signal Ps1, at step 424 the ECU 42 switches the first motor forward drive control signal Ds1 output by the ECU 42 of the control unit 40 from HIGH level to LOW level. The first motor 34 of the webbing take-up device 12 is thereby stopped.

Next, processing similar to the processing of step 222 to step 228 of the flowchart illustrated in FIG. 5 is performed at step 424 to step 432, thereby removing slack from the webbing 18 that is wrapped across the body of the occupant 64 and placing the webbing 18 in a fitted state over the body of the occupant 64.

Note that the rotation position data Nr obtained in the fitting assist function control is a count of the first pulse signal Ps1 output by the first rotary encoder 66 between the fully-stored state of the webbing and the fitted state of the webbing 18 over the body of the occupant 64. Accordingly, when the count N5 of the first pulse signal Ps1 that is started at step 414 becomes greater than or equal to the difference dNr computed at step 412 as the difference between the rotation position data Nr and the count N4 of the first pulse signal Ps1, the amount of the webbing 18 sent out from the spool 16 of the webbing take-up device 12 is greater than or equal to the amount of the webbing 18 that has been sent out from the spool 16 in the fitted state of the webbing 18 over the body of the occupant 64.

It is thus possible to suppress a sense of constraint felt by the occupant 64 from the webbing 18, and in particular a sense of constraint felt around the stomach of the occupant 64 from the lap belt portion of the webbing 18 between the tongue 26 and the anchor plate 22, when the buckle 47 is moved obliquely toward the vehicle rear lower side by drive force of the second motor 56 of the buckle device 44. This thereby enables the commercial appeal of the seatbelt device 10 to be enhanced.

Moreover, in the present exemplary embodiment, when controlling the drive of the first motor 34 of the webbing take-up device 12, there is no need to detect the tension of the webbing 18 or to detect the load of the second motor 56 of the buckle device 44. There is therefore no need for complicated coordination between drive control of the first motor 34 of the webbing take-up device 12 and drive control of the second motor 56 of the buckle device 44. This thereby enables drive control of the first motor 34 of the webbing take-up device 12 and drive control of the second motor 56 of the buckle device 44 to be suppressed from becoming complicated. This thereby enables manufacturing costs of the seatbelt device 10 to be suppressed, and so the commercial appeal of the seatbelt device 10 can be enhanced in this sense, too.

Note that in the second exemplary embodiment, configuration is made in which the first pulse signal Ps1 output by the first rotary encoder 66 of the webbing take-up device 12 is counted as the count N4 until the tongue 26 provided to the webbing 18 is engaged with the buckle 47 of the buckle device 44. However, sometimes the amount of the webbing 18 sent out from the spool 16 in a state in which the tongue 26 is engaged with the buckle 47 of the buckle device 44 is substantially constant irrespective of the physical build or the like of the occupant 64, for example in configurations in which drive force from the second motor 56 moves the buckle 47 sufficiently toward the vehicle front upper side. In such configurations, a fixed constant number may be employed instead of the count N4 of the first pulse signal Ps1 output by the first rotary encoder 66.

Moreover, a configuration may be implemented in which the second exemplary embodiment is combined with the first exemplary embodiment. Namely, configuration may be made in which an amount of the webbing 18 sent out from the spool 16 after the buckle 47 of the buckle device 44 has been engaged is determined based on the difference between the amount of the webbing 18 sent out from the spool 16 of the webbing take-up device 12 in a fitted state over the webbing 18 over the body of the occupant 64, and the amount of webbing 18 sent out from the spool 16 until the tongue 26 provided to the webbing 18 is engaged with the buckle 47 of the buckle device 44.

Accordingly, by combining the present exemplary embodiment with the first exemplary embodiment, even in cases in which the amount of the webbing 18 sent out from the spool 16 of the webbing take-up device 12 in the fitted state over the webbing 18 over the body of the occupant 64 is not constant, it is possible to suppress a sense of constraint felt by the occupant 64 from the webbing 18, and in particular a sense of constraint felt around the stomach of the occupant 64 from the lap belt portion of the webbing 18 between the tongue 26 and the anchor plate 22, when the buckle 47 is moved obliquely toward the vehicle rear lower side by the drive force of the second motor 56 of the buckle device 44.

In each of the exemplary embodiments described above, configuration is made in which the amount of the webbing 18 sent out from the spool 16 varies according to the physical build or the like of the occupant 64. However, for example, the amount of the webbing 18 sent out from the spool 16 may be configured such that a length of the webbing 18 of approximately twice a movement stroke of the buckle 47 by the drive force of the second motor 56 of the buckle device 44 is sent out from the spool 16, or the amount of the webbing 18 sent out from the spool 16 may be configured by a constant length irrespective of the physical build or the like of the occupant 64.

Moreover, in each of the exemplary embodiments described above, there has been no particular mention of the rotation speed of the first motor 34 of the webbing take-up device 12 when fitting the webbing 18 over the body of the occupant 64. However, the rotation speed of the first motor 34 of the webbing take-up device 12 when fitting the webbing 18 over the body of the occupant 64 may, for example, be constant irrespective of the physical build or the like of the occupant 64, or may be varied depending on the physical build or the like of the occupant 64.

Moreover, in each of the exemplary embodiments described above, a specific condition is configured by the physical build (body weight) of the occupant 64, a detector is configured by the load sensor 62 provided to the seat 46 of the vehicle, and one example of a parameter is configured by the load detected by the load sensor 62. However, for example, in cases in which the specific condition is configured by the physical build of the occupant 64, a detector may be configured by an imaging section that images the occupant 64 sitting in the seat 46 in the vehicle cabin, and a parameter may be configured by image data of the occupant 64 imaged by the imaging section.

Moreover, if the seat 46 of the vehicle is configured capable of moving in the vehicle front-rear direction and in the vehicle up-down direction, a detector may be configured by a seat position detector that detects the position of the seat 46, and a specific condition and a parameter may be configured by the position of the seat 46. Moreover, if the through anchor 20 of the seatbelt device 10 is configured so as to be capable of moving, a detector may be configured by a through anchor position detector that detects the position of the through anchor 20, and a specific condition and a parameter may be configured by a position of the through anchor 20. In this manner, there are no particular limitations to the specific conditions and parameters used to determine the amount of the webbing 18 sent out from the spool 16.

In each of the exemplary embodiments described above, configuration is made in which the buckle 47 of the buckle device 44 is moved by drive force of the second motor 56. However, configuration may be made in which drive control of the first motor 34 of the webbing take-up device 12 such as that described above is performed when the buckle 47 is moved by hand in order to engage the tongue 26 with the buckle 47 in a state in which the buckle 47 has been moved toward the vehicle front upper side. Moreover, configuration may be made in which the buckle 47 does not move in the vehicle front-rear direction or the vehicle up-down direction.

The disclosure of Japanese Patent Application No. 2015-244542, filed on Dec. 15, 2015, is incorporated in its entirety by reference herein.

1. A seatbelt device comprising:
a spool that is rotated in a send-out direction in order to send out webbing;
a buckle that is capable of engaging with a tongue provided to the webbing;
a drive section that is driven to rotate the spool in the send-out direction; and
a controller that drives the drive section so as to rotate the spool by a predetermined specific amount in the send-out direction, in response to engagement of the tongue with the buckle,
wherein the buckle is capable of moving in a vehicle up-down direction or in a vehicle front-rear direction, and the controller controls drive of the drive section, in response to engagement of the tongue with the buckle in a state in which the buckle has been moved toward a vehicle upper side or a vehicle front side.

2. The seatbelt device of claim 1, further comprising:
a storage section that stores send-out direction rotation amount data for the spool, the rotation amount data being set according to values of a parameter that fluctuates according to changes in a specific condition; and
a detector that detects a value of the parameter,
wherein the controller drives the drive section by reading from the storage section the rotation amount data corresponding to the parameter value detected by the detector.

3. The seatbelt device of claim 1, wherein the controller drives the drive section so as to send out the webbing from the spool by a length greater than or equal to a difference between a pre-stored amount of the webbing sent out from the spool in a fitted state of the webbing over the body of an occupant, and an amount of the webbing sent out from the spool when the tongue is engaged with the buckle.

4. (canceled)

5. The seatbelt device of claim 2, wherein the specific condition is a physical build (body weight) of an occupant.

6. The seatbelt device of claim 2, wherein:
the detector is a load sensor provided to a vehicle seat;
the specific condition is a body weight of an occupant; and
the parameter is a load detected by the load sensor.

7. The seatbelt device of claim 2, wherein the specific condition is a position of a vehicle seat.
